(19) United States
(12) Patent Application Publication
(10) Pub. No.: US 2014/0114992 A1
(43) Pub. Date: Apr. 24, 2014

(54) SYSTEM AND METHOD FOR AN AWARENESS PLATFORM

(71) Applicant: AVAYA INC., Basking Ridge, NJ (US)

(72) Inventors: John F. BUFORD, Princeton, NJ (US); Mehmet BALASAYGUN, Freehold, NJ (US); Venkatesh KRISHNASWAMY, Holmdel, NJ (US)

(73) Assignee: Avaya Inc., Basking Ridge, NJ (US)

(21) Appl. No.: 13/852,657

(22) Filed: Mar. 28, 2013

Related U.S. Application Data
(60) Provisional application No. 61/717,241, filed on Oct. 23, 2012.

(51) Int. Cl. G06F 17/30

(52) U.S. Cl. CPC G06F 17/30943
USPC 707/755

(57) ABSTRACT

Disclosed herein are systems, methods, and computer-readable storage media for an awareness platform. The system can model, at a context engine, a context for a user, wherein the context is associated with an activity involving the user. Next, the system can analyze the activity to extract a keyword. The system can then generate a context-aware presentation based on the context and data gathered based on the keyword. The system can also present the context-aware presentation to a device associated with the user.

### PRIORITY

This application claims priority to U.S. Provisional Application 61/717,241, filed 23 Oct. 2012, the contents of which are herein incorporated by reference in their entirety.

### BACKGROUND

1. Technical Field

The present disclosure relates to context awareness and more specifically to an awareness platform that is based on contextual information.

2. Introduction

Contextual information can be exploited to provide a richer communication and computing experience for the user. The information landscape relevant to enterprise communication, collaboration, and customer care is large, diverse, and quickly growing. However, finding relevant information, as well as new sources of potentially relevant information for current and future communications can be an extremely daunting and onerous task. Not surprisingly, current solutions are typically limited to a narrow set of information sources that are predetermined by the system. Moreover, current solutions fail to account for the differences in the age of information. Yet information relevance is often affected by the information's age. In addition, current solutions also fail to account for real-time contextual changes. This is a significant limitation, as changes in a communication topic cause context shifts, which can affect the relevance of information. In other words, the information may not be relevant or responsive to the current context if it is not updated as the context shifts. Given these and other limitations of the current solutions, the user's communication and computing experience is largely plagued by outdated, insufficient, and inaccurate contextual information, much to the detriment of the user.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches disclosed herein can be used to generate an awareness platform. The awareness platform can quickly and accurately identify a current context of the user, and automatically provide relevant information and/or sources of information to the user. For example, the awareness platform can be used to generate a context-aware presentation to the user, which can be based on the current context of the user, and can provide the user with relevant streams of information, as well as expertise and connections that are relevant to high-quality decisions and/or communications. The context-aware presentation can be fast and accurate, and can keep pace with context shifts for greater information relevance.

Disclosed are systems, methods, and computer-readable storage media for an awareness platform. The system models, at a context engine, a context for a user, wherein the context is associated with an activity involving the user. The context can be based on the activity. The context can also be based on one or more additional activities involving the user. Moreover, the context can be based on events and/or relevant conditions associated with the activity and/or the user. The activity can include an event, a communication, a conversation, a meeting, a collaboration, an audio comment, an action, etc. The system can analyze and/or process the activity and/or any information associated with the activity in order to model the activity. Also, the system can analyze the activity to extract a keyword. The keyword can be used to understand and/or model the context. Moreover, the keyword can include a topic, a trend, a domain, a person, an entity, an organization, an action, a word, a characteristic, a description, a comment, etc.

The system then generates a context-aware presentation based on the context and data gathered based on the keyword. The data gathered can include, for example, a trend, a pattern, a report, a chart, a news feed, a web page, a document, a description, a summary, media, and/or an analysis, among other things. Moreover, the data gathered can be associated with a user environment, a market, a government, a business, a regulatory body, news information, a social network, a collaboration application, a condition, a sensor network, a user model, a group, an application, an event, an enterprise, and/or statistics, among other things. The activity can be analyzed based on a pace of the activity. The context-aware presentation can then be updated according to the pace of the activity. The pace can relate to an approximate rate of change of focus of the activity.

The system can also present the context-aware presentation to a device associated with the user. The context-aware presentation can represent a current context, for example. The context-aware presentation can include information relevant to the activity involving the user. The user can view the context-aware presentation to inform herself as she participates in the activity. The context-aware presentation can thus provide the user with expertise, streams of communication, relevant connections, and/or other relevant information as the user participates in the activity. The context-aware presentation can anticipate context shifts and refocus the context accordingly.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example awareness platform;

FIG. 3 illustrates an awareness display;

FIG. 4 illustrates an example architecture for a communication session;

FIG. 5 illustrates a first example method embodiment; and

FIG. 6 illustrates a second example method embodiment.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

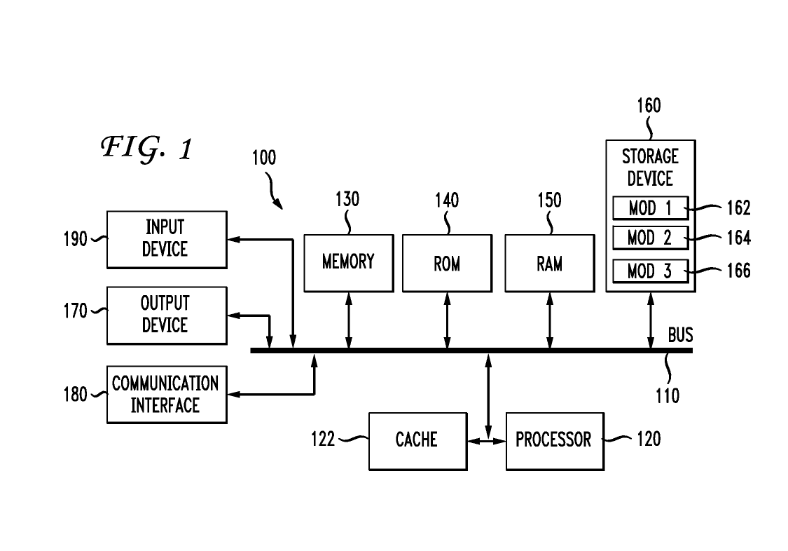

The present disclosure addresses the need for effective use of contextual information for providing a richer communication and computing experience for the user. A system, method and computer-readable media are disclosed which provide contextual information through an awareness platform to improve the user's communication and computing experience. A brief introductory description of a basic general purpose system or computing device in FIG. 1, which can be employed to practice the concepts, is disclosed herein. A more detailed description of contextual information and awareness platforms will then follow. These variations shall be described herein as the various embodiments are set forth. The disclosure now turns to FIG. 1.

With reference to FIG. 1, an exemplary system includes a general-purpose computing device 100, including a processing unit (CPU or processor) 120 and a system bus 110 that couples various system components including the system memory 130 such as read only memory (ROM) 140 and random access memory (RAM) 150 to the processor 120. The computing device 100 can include a cache 122 of high speed memory connected directly with, in close proximity to, or integrated as part of the processor 120. The computing device 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer-readable storage media provide nonvolatile storage of computer-readable instructions, data structures, program modules and other data for the computing device 100. In one aspect, a hardware module that performs a particular function includes the software component stored in a tangible computer-readable storage medium in connection with the necessary hardware components, such as the processor 120, bus 110, display 170, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the computing device 100 is a small, handheld computing device, a desktop computer, or a computer server.

Although the exemplary embodiment described herein employs the hard disk 160, other types of computer-readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Tangible computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations described below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited tangible computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored in other computer-readable memory locations.

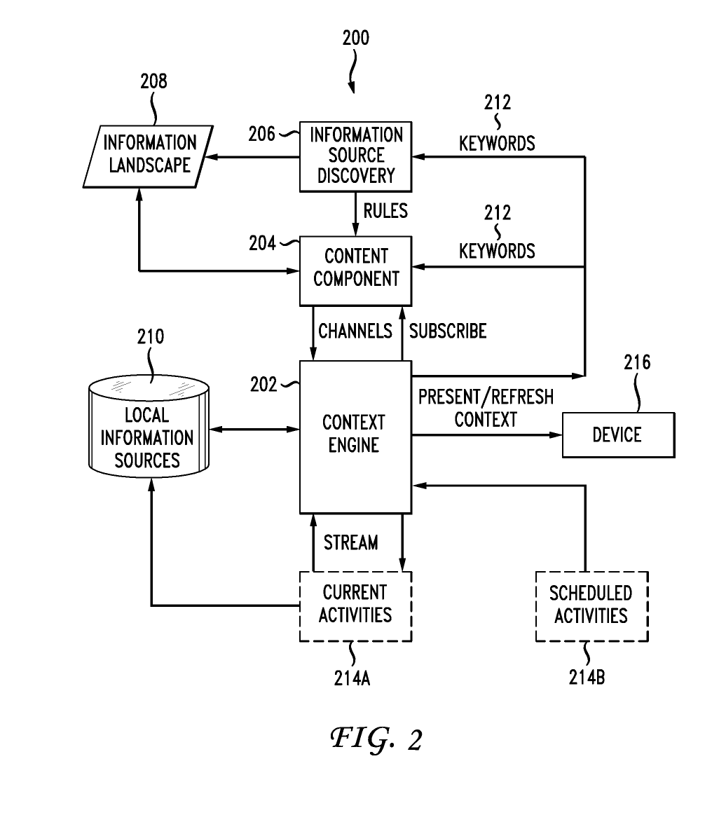

Having disclosed some components of a computing system, the disclosure now turns to FIG. 2, which illustrates an example awareness platform 200. Context engine 202 can create a context for a user in one or more activities, such as communications or meetings. The context engine 202 can also maintain and/or update a context for one or more users in an activity. Moreover, the context engine 202 can identify an activity, a relevant source of information, and/or relevant information based on keyword 212. The keyword 212 can include a topic, a domain, semantics, a person, an organization, a specific keyword, and/or any other entity or information. The context engine 202 can use information from local information sources 210 and/or the information landscape 208 to compute the context for the user in an activity. The local information sources 210 can include, for example, enterprise information sources or local network sources. Moreover, the information landscape 208 can include one or more sources, such as a network, an overlay, a registry, a portal, a gateway, a content distribution network, the Internet, a database, and/or any other content repository. For example, the information landscape 208 can include websites, Really Simple Syndication (“RSS”) feeds, blogs, personal communications history, social networks, sensor networks, home automation networks, smart grid, vehicular networks, business analytics, etc.

Furthermore, the information from the information landscape 208 can include one or more aspects of information, such as external trends and events, activities and patterns, business analytics, data from sensor networks, information from a user model, etc. The external trends and events can include trends and events affecting the user's activity, such as events from financial markets, regulatory decisions, customer account actions, new technology, news, reports, announcements, etc. Information relating to external trends and events can be extracted, for example, from news sites, RSS feeds, blogs, social networks, the Internet, etc. The activities and patterns can relate to communication activities and patterns, for example. In some aspects, the activities and patterns are from the user's social network. For example, the activities and patterns can include trends in a social network, such as increasing chatter about a specific topic. The business analytics can include technologies for continuous iterative analysis of business performance. Here, the activities of a user can be related to real-time business analytics. Data from sensor networks can include people-centric sensing, environment sensing, health sensing, safety sensing, urban monitoring/surveillance, sensing overlays, etc. The data from the sensor networks can also be aggregated for a more complete awareness picture. Moreover, the information from the information landscape 208 can include information from a user model.

An information source discovery (ISD) component 206 can search the information landscape 208 for new publishers and/or sources that are relevant to keyword 212. This allows the context engine 202 to automatically find relevant information sources and/or adapt to relevant information sources. The context engine 202 can inform the ISD 206 of new topics, domains, semantics, people, organizations, keywords, and/or other entities. The ISD 206 can update its discovery based on new information from the context engine 202. Users can also supplement the information landscape 208 with additional sources. For example, a user or administrator can identify new sources, subscribe to new sources, authorize the use of new sources, test new sources, etc. ISD 206 can also manage incoming information according to different access rights, as information sources can have access restrictions. Moreover, ISD 206 can also provide source selection rules for the content component 204. The source selection rules can depend on the keyword 212, for example. The ISD 206 can add new subscription rules to the content component 204 for any new sources. The content component 204 can push the information from the ISD component 206 and/or the information landscape 208 to one or more channels, as prescribed by the context engine 202. The channels can allow the context engine 202 to simultaneously and independently receive separate information to compute multiple contexts. Also, the content component 204 can define one or more new channels for each new source.

The content component 204 can include a subscriptions component, a filtering component, and/or a fusing component. The subscriptions component of the content component 204 can create a subscription with one or more sources and/or initiate a periodic query/polling loop for one or more sources. In some aspects, the subscription can depend on the type of information source. The context engine 202 can also change subscriptions to channels at any time. The context engine 202 can subscribe to new sources identified by the IDS 206 via the content component 204. Moreover, the filtering component of the content component 204 can be used to narrow the data being obtained. This can depend on the topic range of the source, for example. Further, the fusion component of the content component 204 can fuse information into a higher semantic level. This fusion can depend, in some aspects, on the level of detail of the incoming information with respect to the level needed for a context computation. The content component 204 can enable algorithms to filter and/or fuse information according to new information from the context engine 202. The subscription, filtering, and/or fusing performed by the content component 204 can be based on the keyword 212. The keyword 212 can change as the context changes, and thus, the scope of subscription, filtering, and/or fusing can also change in scope. Moreover, the context engine 202 can change the keyword 212 at any time. For example, the context engine 202 can inform the content component 204 of new topics, domains, semantics, people, organizations, keywords, and/or other entities.

The context engine 202 can create a new context for each user in a communication stream and/or activity. A communication stream can include a communication exchange between parties, such as a short message service (SMS) message, an instant message (IM), an email, a phone call, a video call, a web conference, a shared virtual reality, a social network, a blog, etc. A communication stream can also be from a user to an application and/or agent. Further, a communication stream can be short term, long term, or even pervasive. Moreover, a communication stream can be ad hoc or scheduled by one or more users. Also, the communication stream can originate from any endpoint and/or include any endpoint. A communication stream can also be dynamic in the number of participants, the number and/or type of endpoints, the types of media, and/or types of information sources. A communication stream can also incorporate additional information sources.

The context engine 202 can perform a context computation for each context. Here, the context engine 202 can prioritize new information according to the current topics, activities, communications, domains, speakers, etc. The context engine 202 can also generate agenda-driven or topic-driven search and query terms, and/or generate a keyword-driven semantic lookup. For example, during a meeting, management counsel may refer to a relevant Supreme Court case dealing with flood control, which the analyst may not already be following. In response, the context engine 202 can increase the rank of litigation news feeds, and generate a search/query with the following as possible search terms: “Supreme Court flood control”, “flood control case.” The context engine 202 can also generate a semantic lookup, such as flood risk and/or flood insurance, for example. The context engine 202 can then obtain information and/or sources based on the litigation news feeds, the search/query, and/or the semantic lookup, and perform a context computation based on this information. To compute the context, the context engine 202 can also perform various other operations. For example, the context engine 202 can model, match, search, query, filter, fuse, predict, and/or pace information to compute the context. The context engine 202 can also use the keyword 212 to perform any of the operations. For example, the context engine 202 can use the keyword 212 to search for additional information and/or sources. As mentioned earlier, the keyword 212 here can include a topic, a domain, a person, an organization, a keyword, other entities, etc.

The context engine 202 can also manage the pace of the presentation and/or calculation of context. In some embodiments, the pace of the presentation and/or calculation of context can be according to the pace of the communication session and/or the activity involving the user. Moreover, the context engine 202 can detect and/or anticipate context shifts in an activity and/or communication, and refocus the context accordingly. Pacing of context can be due to the dynamics of context shifts. Pace can refer to the rate of change of focus in an activity. For pacing, the context engine 202 can analyze various predictors of pace, such as an agenda, a speaker, a participant, prior history, slides per speaker, pages of content, user inputs, schedules, etc. The context engine 202 can use pace to recognize context shifts, control rate of display change, estimate available time to compute relevant information, estimate available time to obtain and/or analyze new information, estimate the amount of relevant information to include in a context presentation, filter the amount of sources and/or relevant information to use for a context presentation, etc.

Further, the context engine 202 can present and/or refresh a context for current activities 214A based on relevant information. The context engine 202 can also prepare for scheduled activities 214B by assembling relevant information based on session collateral, prior session history, metadata, roster, etc. Context can be presented via an awareness display. The awareness display can be based on user interface (UI) and/or user experience (UX) principles and/or dynamics of communication, for example. The awareness display can be updated/refreshed based on pace and/or context shifts.

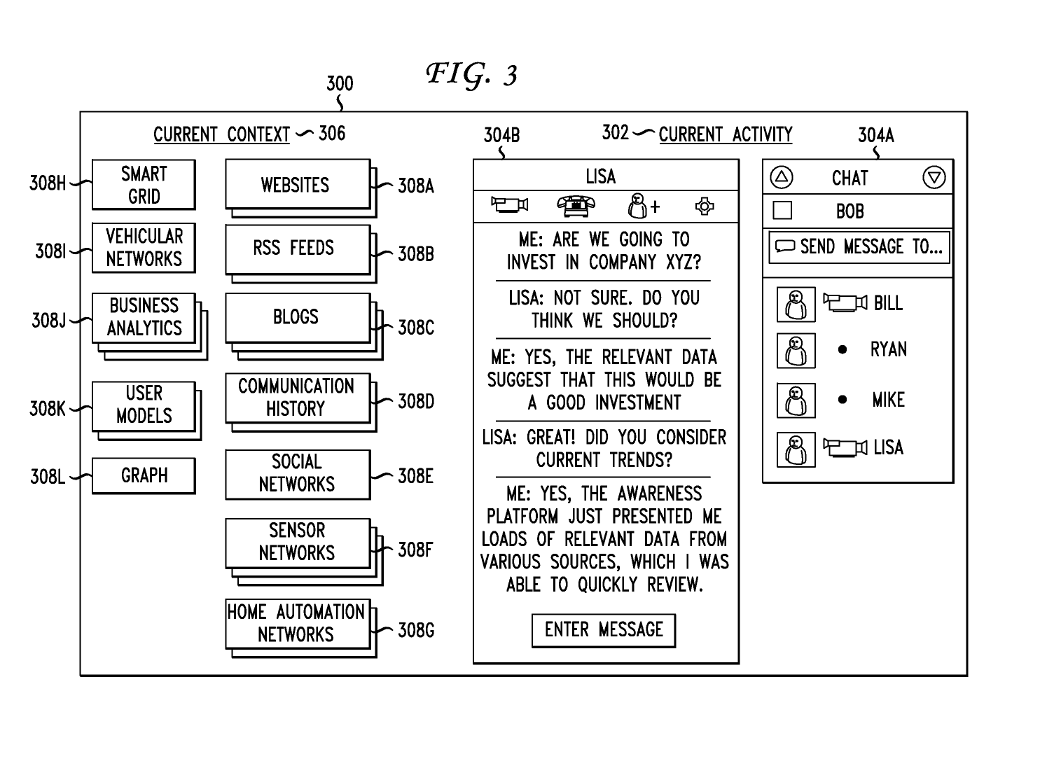

FIG. 3 illustrates an example of an awareness display 300. The awareness display 300 can be a context-aware presentation, for example. Also, the awareness display 300 can be based on UI and/or UX principles and/or dynamics of communication, for example. In FIG. 3, the awareness display 300 illustrates a current activity 302 involving the user. Here, the user has chat application 304A open, and is involved in a communication session 304B with a contact from the chat application 304A. The awareness display 300 can then display a current context 306 based on the current activity 302. Moreover, the current context 306 can be based on one or more aspects of the current activity 302, such as the type of activity, the topic(s), the domain(s), the people involved, the organization(s) related to the activity, a keyword associated with the activity, semantics, etc. Further, the information and/or sources of information 308A-L for the current context 306 can also be based on the current activity 302. For example, if the current activity 302 includes a chat conversation about company XYZ, then the current context 306 can include sources and information related to company XYZ. In this example, the websites 308A can be related to company XYZ and/or include information relevant to company XYZ. Likewise, the business analytics 308J can include business performance information about company XYZ.

The current context 306 can narrow the information and/or sources 308A-L based on the current activity 302. For example, the current context 306 can filter information and/or sources based on the current activity 302, to limit the amount of information and/or sources used/displayed for the current context 306. The current context 306 can also search/query the information sources 308A-L to find information relevant to the current activity 302. Moreover, the current context 306 can rank information and/or sources based on the current activity 302. Thus, for example, the current context 306 can present information in a ranked order, such that the most relevant information is presented first. The current context 306 can also present information that is aggregated from one or more of the sources 308A-L. Here, the current context 306 can fuse portions of information to create an aggregate of relevant information.

Further, the awareness display 300 can update the current context 306 based on the current activity 302. In some embodiments, the awareness display 300 can manage the pace of the presentation and/or calculation of the current context 306 according to the pace of the current activity 302. For example, the current context 306 can be recalculated and/or refreshed as the current activity 302 shifts to a different activity, topic, person, application, agenda, domain, entity, etc. The awareness display 300 can anticipate context shifts in the current activity 302, and refocus the context accordingly. The awareness display 300 can use the rate of change of focus in the current activity 302 to recognize context shifts, control rate of display change, estimate available time to compute relevant information, anticipate context shifts, etc.

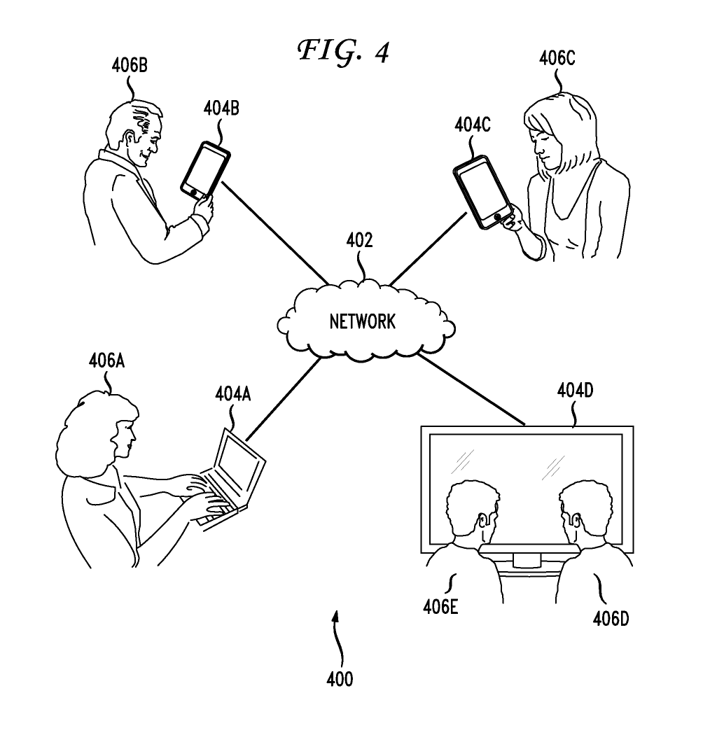

FIG. 4 illustrates an example architecture 400 for a communication session. Users 406A-E can participate in a communication session via devices 404A-D. The devices 404A-D can include any network device with a display and/or connected to a display. For example, the devices 404A-D can include a mobile phone, a laptop, a tablet computer, a smart television, a game system, a conference system, a portable media player, etc. The devices 404A-D, however, are not limited to devices with a display and/or connected to a display. Other non-display devices capable of non-visual presentations can also be contemplated such as a device cable of audio playback.

The devices 404A-D can communicate with each other via network 402. The network 402 can include a public network, such as the Internet, but can also include a private or quasi-private network, such as an intranet, a home network, a virtual private network (VPN), a shared collaboration network between separate entities, etc. Indeed, the principles set forth herein can be applied to many types of networks, such as local area networks (LANs), virtual LANs (VLANs), corporate networks, wide area networks, and virtually any other form of network.

The communication session can include a communication exchange between two or more parties, such as an SMS message, an IM message, an email, a phone call, a video call, a web conference, a shared virtual reality, a social network, a blog, etc. The communication session can also include an exchange between a user and an application and/or a virtual agent, for example. The communication session can be short term, long term, or even pervasive. The communication session can be ad hoc or scheduled in advance. Moreover, the communication session can originate from any of the devices 404A-D. Further, the communication session can be dynamic in the number of participants, the number and/or type of devices, the types of media, the types of information, the types of applications, the types of channels, the number and/or type of protocols, etc.

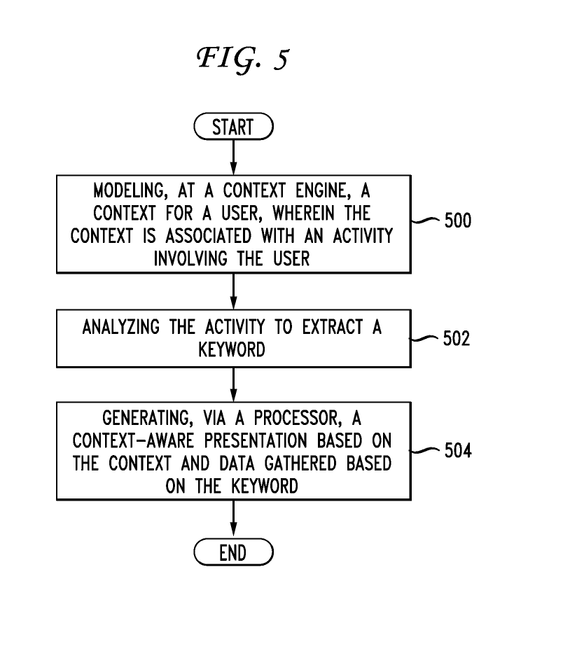

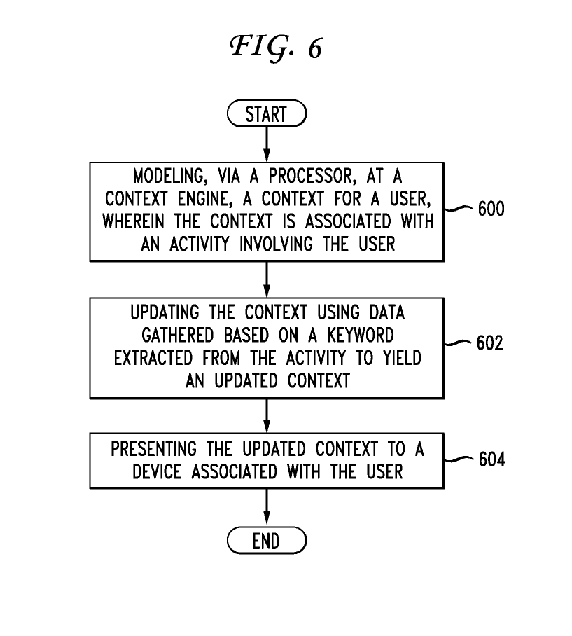

Having disclosed some basic system components and concepts, the disclosure now turns to the exemplary method embodiments shown in FIGS. 5 and 6. For the sake of clarity, the methods are described in terms of an exemplary system 100, as shown in FIG. 1, configured to practice the methods. The steps outlined herein are exemplary and can be implemented in any combination thereof, including combinations that exclude, add, or modify certain steps.

FIG. 5 illustrates a first example method embodiment. The system 100 models, at a context engine, a context for a user, wherein the context is associated with an activity involving the user (500). The context can be based on the activity involving the user. The context can also be based on additional activities involving the user. The activity can include a communication session, such as an exchange between the user and another user, a meeting, a conversation, a collaboration, an audio comment, an event, an application, a task, etc. Next, the system 100 analyzes the activity to extract a keyword (502). The keyword can include a topic, a domain, a person, an entity, an organization, a word, a flag, a name, a trend, semantics, and/or any other information associated with the activity involving the user. The system 100 then generates a context-aware presentation based on the context and data gathered based on the keyword (504). The context-aware presentation can include a current context for the user. For example, the context-aware presentation can include information relevant to the activity involving the user. The data gathered can include, for example, a trend, a pattern, a report, an analysis, a chart, a summary, a comment, a document, news feed, statistics, a web page, among other things. Moreover, the data gathered can be related to the activity involving the user. Further, the data gathered can also be related to a user environment, an application, a software environment, a market, a government, a regulatory body, news information, a social network, a collaboration application, a sensor network, a user model, an enterprise, a blog, a web page, a statistic, a business, an event, a conversation, an activity, an institution, among other things.

The data can be data gathered from one or more relevant sources. The relevant sources can be identified and/or selected based on the keyword, and/or any other information. Some examples of relevant sources can include websites, RSS feeds, blogs, the Internet, personal communications history, social network, sensor networks, home automation networks, smart grid, vehicular networks, business analytics, user models, databases, other networks, etc. The relevant sources can also include local sources, such as local enterprise information sources and/or local network sources, for example.

The system 100 can extract, from the relevant sources, external events and trends related to the activity, and use this information to generate the context awareness platform. For example, the system 100 can analyze the relevant sources to identify relevant events and trends in the financial markets, relevant regulatory decisions, customer account actions, new technology, consumer trends, sales events and/or trends, product release announcements, etc. The system 100 can also analyze activities and patterns in the user's current and/or past communications to obtain additional relevant information. For example, the system 100 can analyze activities and patterns in the user's social network to extract relevant information, such as increasing chatter about a specific topic. Moreover, the system 100 can relate the activity to real-time business analytics to obtain relevant business analytics for the awareness platform. For example, the system 100 can analyze real-time business analytics for continuous, iterative analysis of business performance information to incorporate into the awareness platform. The system 100 can also incorporate relevant information from sensor networks into the awareness platform. For example, the system 100 can obtain information from people-centric sensing, environment sensing, safety sensing, health sensing, urban monitoring and/or surveillance, sensing overlays, etc. The system 100 can also aggregate the information from the sensor networks and incorporate combined information into the awareness platform, for example. The system 100 can also use information from user models for the awareness platform. The user models can provide useful information about the user and/or the organization, for example.

Furthermore, the system 100 can present the context-aware presentation to the user. The context-aware presentation can provide the user with a current context. The current context can provide the user with relevant information as she participates in the activity. Consider the following example scenario. An investment broker receives a call from a client about a particular investment, and a buy-sell-hold decision needs to be made very quickly because of an event taking place in the market on that day. Moreover, the client wants an answer immediately. That broker needs to quickly pull up records and relevant information to understand the client's risk profile, investment history, current portfolio and positions, and any other information that can help the broker make a recommendation. At the same time, the broker needs to understand what is being covered in the news media; what is being said internally within the investment firm—for example, among other brokers who are watching movement in pre-market prices or on internal microblogs; what trends and patterns are emerging from the markets; what additional commentary is issued externally, such as from regulators or other analysts; and even what “chatter” might be detected across relevant social media sites, which could impact the investment from a reputational perspective.

Here, the system 100 can generate a context-aware presentation, which is aware of the broker, the broker's context and environment, the streams of information, the expertise and connections that are relevant to a decision, etc. The context-aware presentation can immediately and/or automatically bring together relevant information from all the relevant sources, which the system 100 can present to the broker, so the broker can quickly sift through all of the relevant information and communicate with others as needed. Thus, even as the broker is talking with the client, the information streams and/or communication links are available to the broker, and can be presented to the broker, enabling an informed recommendation. This scenario illustrates an example in the financial services field; however, similar applications can be implemented in any other context, such as emergency response contact centers, technical support centers, sales support centers, corporate shared services centers around the world, conferencing services, telehealth services, etc.

The system 100 can also correlate, filter, aggregate, fuse, and/or prioritize information from any of these sources for added value. For example, the system 100 can correlate external events, such as regulatory decisions, to specific trends, such as manufacturing trends, or specific business performance information obtained from real-time business analytics. As another example, if the amount of relevant information extracted is great, the system 100 can filter the information to narrow the information to a more manageable amount. Moreover, the system 100 can analyze the activity based on a pace of the activity. The pace can relate to an approximate rate of change of focus of the activity, for example. The system 100 can recognize context shifts and control the rate of display change. The system 100 can also use the pace to estimate available time to compute relevant information.

FIG. 6 illustrates a second example method embodiment. The system 100 can model, at a context engine, a context for a user, wherein the context is associated with an activity involving the user (600). Here, the context can be based on the activity involving the user. The context can also be based on one or more additional activities involving the user. Moreover, the context can be additionally based on one or more conditions associated with the activity and/or the user's environment. The user's environment can include, for example, an application used by the user and/or an event the user is participating in. Next, the system 100 can update the context using data gathered based on a keyword extracted from the activity to yield an updated context (602). The data can be gathered from any relevant sources. Relevant sources can be pre-configured on the system 100 and/or selected by the user. Relevant sources can also be discovered by the system 100 based on the context of the user and/or the activity involving the user. Some examples of relevant sources can include websites, RSS feeds, blogs, the Internet, personal communications history, social network, sensor networks, home automation networks, smart grid, vehicular networks, business analytics, user models, databases, other networks, etc. The relevant sources can also include local sources, such as local enterprise information sources and/or local network sources, for example.

The data gathered can include, for example, a trend, a pattern, a report, an analysis, a chart, a summary, a comment, a document, news feed, statistics, a web page, among other things. Moreover, the data gathered can be related to the activity involving the user. Further, the data gathered can also be related to a user environment, an application, a software environment, a market, a government, a regulatory body, news information, a social network, a collaboration application, a sensor network, a user model, an enterprise, a blog, a web page, a statistic, a business, an event, a conversation, an activity, an institution, among other things.

The system 100 can then present the updated context to a device associated with the user (604). The updated context can provide the user with relevant information as she participates in the activity. Moreover, the updated context can be presented and/or updated automatically as the user participates in the activity. The pace can relate to an approximate rate of change of focus of the activity, for example. The system 100 can recognize context shifts. For example, the system 100 can analyze the activity based on a pace of the activity in order to control the rate of display change based on the pace of the activity. The system 100 can also use the pace to estimate available time to compute relevant information. The pace can relate to an approximate rate of change of focus of the activity, for example.

Embodiments within the scope of the present disclosure may also include tangible and/or non-transitory computer-readable storage media for carrying or having computer-executable instructions or data structures stored thereon. Such tangible computer-readable storage media can be any available media that can be accessed by a general purpose or special purpose computer, including the functional design of any special purpose processor as described above. By way of example, and not limitation, such tangible computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. Claim language reciting “at least one of a set indicates that one member of the set or multiple members of the set satisfy the claim.

We claim:

1. A method comprising:
modeling, at a context engine, a context for a user, wherein the context is associated with an activity involving the user;
analyzing the activity to extract a keyword; and
generating, via a processor, a context-aware presentation based on the context and data gathered based on the keyword.

2. The method of claim 1, wherein the activity comprises at least one of a conversation, a meeting, a collaboration, and an audio comment.

3. The method of claim 1, wherein the keyword comprises at least one of a topic, a trend, a domain, a person, an entity, and an organization.

4. The method of claim 1, wherein the data gathered comprises at least one of a trend, a pattern, a report, and an analysis, and wherein the data is associated with at least one from among a user environment, a market, a government, a regulatory body, news information, a social network, a collaboration application, a sensor network, a user model, and an enterprise.

5. The method of claim 4, wherein the user environment comprises at least one of an application used by the user and an event the user is participating in.

6. The method of claim 1, wherein analyzing the activity is done based on a pace of the activity, wherein the pace corresponds to an approximate rate of change of focus of the activity.

7. The method of claim 1, further comprising presenting the context-aware presentation to a device associated with the user, wherein the context-aware presentation comprises information relevant to the activity.

8. The method of claim 1, wherein the context is based on the activity.

9. A method comprising:
modeling, via a processor, at a context engine, a context for a user, wherein the context is associated with an activity involving the user;
updating the context using data gathered based on a keyword extracted from the activity to yield an updated context; and
presenting the updated context to a device associated with the user.

10. The method of claim 9, wherein the context is based on the activity.

11. The method of claim 9, wherein the activity comprises at least one of a conversation, a communication, a meeting, a collaboration, and an audio comment.

12. The method of claim 9, wherein the keyword comprises at least one of a topic, a trend, a domain, a person, an entity, and an organization.

13. The method of claim 9, wherein the data gathered comprises at least one of a trend, a pattern, a report, and an analysis, and wherein the data is associated with at least one from among a user environment, a market, a government, a regulatory body, news information, a social network, a collaboration application, a sensor network, a user model, and an enterprise.

14. The method of claim 13, wherein the user environment comprises an application used by the user and an event the user is participating in.

15. A system comprising:
a processor; and
a computer-readable storage device storing instructions which, when executed by the processor, cause the processor to perform operations comprising:
modeling, at a context engine, a context for a user, wherein the context is associated with an activity involving the user;
analyzing the activity to extract a keyword; and
generating a context-aware presentation based on the context and data gathered based on the keyword.

16. The system of claim 15, wherein the context is based on the activity, and wherein the activity comprises at least one from among a conversation, a communication, a meeting, a collaboration, and an audio comment.

17. The system of claim 15, wherein the keyword comprises at least one of a topic, a trend, a domain, a person, an entity, and an organization.

18. The system of claim 15, wherein the context is based on the activity.

19. A computer-readable storage device storing instructions which, when executed by a processor, cause the processor to perform operations comprising:
modeling, at a context engine, a context for a user, wherein the context is associated with an activity involving the user;
analyzing the activity to extract a keyword; and
generating, via a processor, a context-aware presentation based on the context and data gathered based on the keyword.

20. The computer-readable storage device of claim 19, wherein the context is based on the activity, and wherein the activity comprises at least one from among a conversation, a communication, a meeting, a collaboration, and an audio comment.
